(19) United States
(12) Patent Application Publication
(10) Pub. No.: US 2025/0313372 A1
(43) Pub. Date: Oct. 9, 2025

(54) TRAY

(71) Applicant: Samsung Display Co., LTD., Yongin-si (KR)

(72) Inventors: Young Dae SONG, Yongin-si (KR); Young Moo KWON, Yongin-si (KR); Hyo Seok YANG, Yongin-si (KR); Hee Sung LIM, Yongin-si (KR)

(73) Assignee: Samsung Display Co., LTD., Yongin-si (KR)

(21) Appl. No.: 18/985,826

(22) Filed: Dec. 18, 2024

(30) Foreign Application Priority Data
Apr. 4, 2024 (KR) 10-2024-0045855

(51) Int. Cl. B65D 1/36; B65D 85/68

(52) U.S. Cl. CPC B65D 1/36; B65D 85/68; B65D 2585/6837

(57) ABSTRACT

A tray includes a loading area where a display panel is loaded, a side wall disposed on a surface of the loading area to surround the loading area, and an air flow path located in the side wall to provide a passage for air outside the side wall to flow into the loading area. The air flow path is bent at least once.

### CROSS REFERENCE TO RELATED APPLICATION(S)

This application claims priority to and benefits of Korean Patent Application No. 10-2024-0045855 under 35 U.S.C. 119, filed on Apr. 4, 2024, in the Korean Intellectual Property Office (KIPO), the entire contents of which are incorporated herein by reference.

### BACKGROUND

### 1. Technical Field

The disclosure relates to a tray.

### 2. Description of the Related Art

As the information-oriented society evolves, various demands for display devices are ever increasing. For example, display devices are being employed by a variety of electronic devices such as smart phones, digital cameras, laptop computers, navigation devices, and smart televisions.

As such display devices, a variety of types of display devices such as liquid-crystal display (LCD) devices and organic light-emitting display (OLED) devices are currently used. Among them, an organic light-emitting display device displays images by using an organic light-emitting element that emits light as electrons and holes recombine. Such an organic light-emitting display device includes multiple transistors for providing a driving current to the organic light-emitting element.

In particular, display panels such as an organic light-emitting display panel are becoming smaller and thinner. Accordingly, it is required to prevent defects from occurring during the process of loading and transporting such display panels.

Typically, display panels may be loaded, transported, and stored on trays while going through several fabrication processes. A tray may include a loading area for loading a display panel, and an air flow path for flowing air outside the tray may be formed in the loading area.

### SUMMARY

Aspects of the disclosure provide a tray that can prevent a loading area for loading a display panel and a side wall from being bent by forming an air flow path located in the side wall that is bent at least once.

However, embodiments of the disclosure are not limited to those set forth herein. The above and other embodiments of the disclosure will become more apparent to one of ordinary skill in the art to which the disclosure pertains by referencing the detailed description of the disclosure given below.

According to an embodiment of the disclosure, a tray may include a loading area where a display panel is loaded, a side wall disposed on a surface of the loading area to surround the loading area, and an air flow path located in the side wall to provide a passage for air outside the side wall to flow into the loading area. The air flow path may be bent at least once.

The side wall may have a first side extended in a first direction and a second side extended in a second direction intersecting the first direction, a length of the first side may be smaller than a length of the second side, and the air flow path may be located on the second side of the side wall.

The air flow path may include an inflow path extended from an outer surface of the side wall toward the loading area, an inclined path extended from the inflow path toward the loading area the inflow path and the inclined path extending different directions, and a discharge path extended from the inclined path to the loading area.

A first end of the inclined path that is connected to the discharge path may be closer to the first side than a second end of the inclined path that is connected to the inflow path.

The discharge path and the inflow path may be extended in a same direction.

The air flow path may further include an inflow expanded path disposed at an end of the inflow path that is located closer to the outer surface of the side wall. A cross-sectional area of the inflow expanded path may be greater than a cross-sectional area of the inflow path viewed in the first direction.

The cross-sectional area of the inflow expanded path may gradually increase toward the outer surface of the side wall.

The air flow path may further include a discharge expanded path disposed at an end of the discharge path that is located closer to the loading area. A cross-sectional area of the discharge expanded path may be greater than a cross-sectional area of the discharge path viewed in the first direction.

The cross-sectional area of the discharge expanded path may gradually increase toward the loading area.

The air flow path may be recessed from a surface of the side wall in a thickness direction of the side wall, and a depth of the air flow path may be greater than half a thickness of the side wall.

A bottom surface of the air flow path in the thickness direction of the side wall may be formed as a curved surface.

According to an embodiment of the disclosure, a tray may include a loading area where a display panel is loaded, a side wall disposed on a surface of the loading area to surround the loading area, and a plurality of air flow paths located in the side wall to provide passages for air outside the side wall to flow into the loading area. The plurality of air flow paths may be extended from an outer surface of the side wall to the loading area, and one of the plurality of air flow paths and another one of the plurality of air flow paths may have different lengths.

The side wall may have first sides extended in a first direction and second sides extended in a second direction intersecting the first direction, a length of each of the first sides may be smaller than a length of each of the second sides, and the plurality of air flow paths may be located on the second sides of the side wall.

The side wall may be formed in a rectangular shape in a plan view, the plurality of air flow paths may include a first air flow path and a second air flow path, the first air flow path may be located on one of the second sides adjacent to a vertex, and the second air flow path may be located on another one of the second sides adjacent to another vertex located diagonally opposite to the vertex.

The first air flow path may include a first inflow path extended from the outer surface of the side wall toward the loading area, a first inclined path extended from the first inflow path toward the loading area, the first inflow path and the first inclined path extending different directions, and a first discharge path extended from the first inclined path to the loading area. The second air flow path may include a second inflow path extended from the outer surface of the side wall toward the loading area, a second inclined path extended from the second inflow path toward the loading area, the second inflow path and the second inclined path extending different directions, and a second discharge path extended from the second inclined path to the loading area. A length of the first inclined path may be smaller than a length of the second inclined path.

A first end of the first inclined path that is connected to the first discharge path may be closer to one of the first sides adjacent to the vertex than a second end of the first inclined path that is connected to the first inflow path, and a first end of the second inclined path that is connected to the second discharge path may be closer to another one of the first sides adjacent to the another vertex than a second end of the second inclined path that is connected to the second inflow path.

The plurality of air flow paths may further include a third air flow path and a fourth air flow path, the third air flow path may be located on the one of the second sides, and the fourth air flow path may be located on the another one of the second sides.

The third air flow path may face the second air flow path with the loading area between the second air flow path and the third air flow path, and the fourth air flow path may face the first air flow path with the loading area between the first air flow path and the fourth air flow path.

The third air flow path may include a third inflow path extended from the outer surface of the side wall toward the loading area, a third inclined path extended from the third inflow path toward the loading area, the third inflow path and the third inclined path extending different directions, and a third discharge path extended from the third inclined path to the loading area. The fourth air flow path may include a fourth inflow path extended from the outer surface of the side wall toward the loading area, a fourth inclined path extended from the fourth inflow path toward the loading area, the fourth inflow path and the fourth inclined path extending direction directions, and a fourth discharge path extended from the fourth inclined path to the loading area. A length of the third inclined path may be equal to a length of the fourth inclined path.

A first end of the third inclined path that is connected to the third discharge path may be closer to the another one of the first sides adjacent to the another vertex than a second end of the third inclined path that is connected to the third inflow path, and a first end of the fourth inclined path that is connected to the fourth discharge path may be closer to the one of the first sides adjacent to the vertex than a second end of the fourth inclined path that is connected to the fourth inflow path.

According to an embodiment of the disclosure, the tray may prevent a loading area for loading a display panel and a side wall of a tray from being bent by forming an air flow path located in the side wall that is bent at least once.

The effects of the disclosure are not limited to those mentioned above and more various effects are included in the following description of the disclosure.

### BRIEF DESCRIPTION OF THE DRAWINGS

The above and other aspects and features of the disclosure will become more apparent by describing in detail embodiments thereof with reference to the attached drawings, in which:

FIG. 1 is a plan view showing a tray according to a first embodiment of the disclosure.

FIG. 2 is an enlarged view of portion A of FIG. 1.

FIG. 3 is a side view of the tray viewed from a first air flow path of FIG. 1.

FIG. 4 is a plan view showing a tray according to a second embodiment of the disclosure.

FIG. 5 is an enlarged view of portion B of FIG. 4.

FIG. 6 is a side view of the tray viewed from a second air flow path of FIG. 4.

FIG. 7 is a plan view showing a tray according to a third embodiment of the disclosure.

FIG. 8 is an enlarged view of portion C of FIG. 7.

FIG. 9 is an enlarged view of portion D of FIG. 7.

FIG. 10 is a side view of the tray viewed from the first air flow path and the third air flow path of FIG. 7.

FIG. 11 is a side view of the tray viewed from the second air flow path and the fourth air flow path of FIG. 7.

### DETAILED DESCRIPTION OF THE EMBODIMENTS

Advantages and features of the disclosure and methods to achieve them will become apparent from the descriptions of embodiments hereinbelow with reference to the accompanying drawings. However, the disclosure is not limited to embodiments disclosed herein but may be implemented in various different ways. The embodiments are provided for making the disclosure of the disclosure thorough and for fully conveying the scope of the disclosure to those skilled in the art.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element. Like reference numerals denote like elements throughout the descriptions. The figures, dimensions, ratios, angles, numbers of elements given in the drawings are merely illustrative and are not limiting.

Although terms such as first, second, etc. are used to distinguish arbitrarily between the elements such terms describe, and thus these terms are not necessarily intended to indicate temporal or other prioritization of such elements. These terms are used to merely distinguish one element from another. Accordingly, as used herein, a first element may be a second element within the technical scope of the disclosure.

Features of various example embodiments of the disclosure may be combined partially or totally. As will be clearly appreciated by those skilled in the art, technically various interactions and operations are possible. Various example embodiments can be practiced individually or in combination.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

Hereinafter, embodiments of the disclosure will be described in detail with reference to the accompanying drawings.

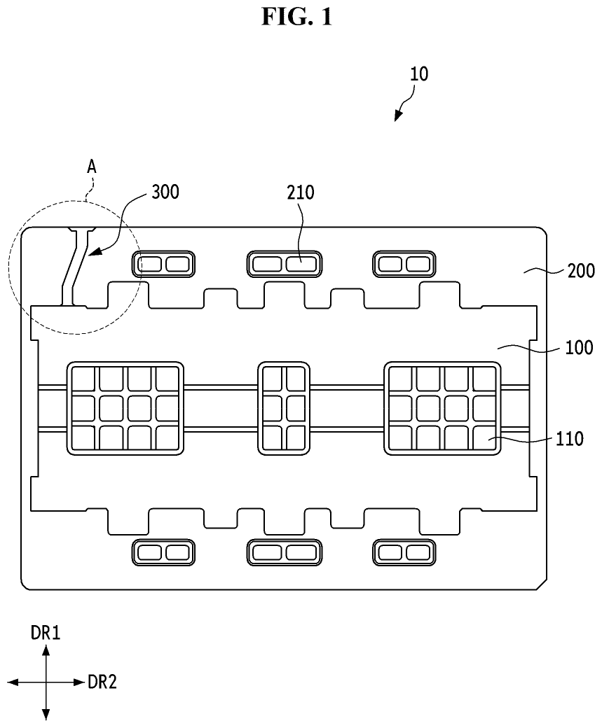

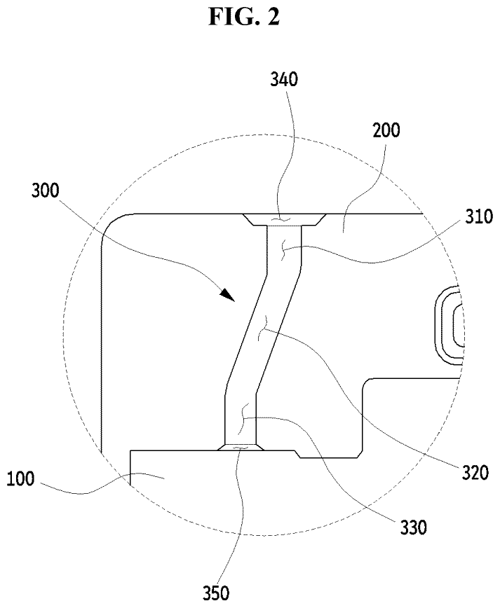

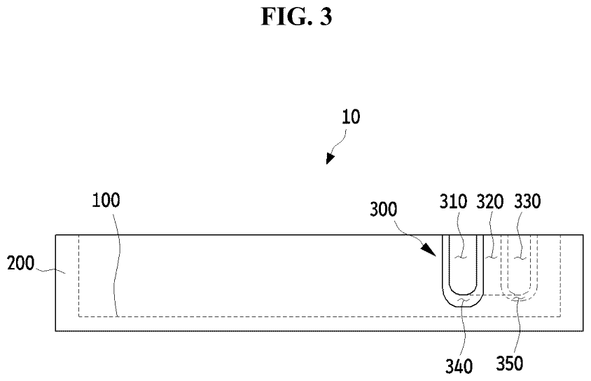

FIG. 1 is a plan view showing a tray 10 according to a first embodiment of the disclosure. FIG. 2 is an enlarged view of portion A of FIG. 1. FIG. 3 is a side view of the tray 10 viewed from a first air flow path 300 of FIG. 1.

Referring to FIGS. 1 to 3, the tray 10 according to the first embodiment of the disclosure may load a display panel (not shown), and may transport and store the loaded display panel. The tray 10 may prevent the display panel from being damaged while transporting and storing the display panel. The tray 10 may be made of a polymer compound that can be injection molded in consideration of process convenience and fabrication cost. The polymer compound may include at least one of polypropylene (PP), polyethylene terephthalate (PET), polyvinyl chloride (PVC), acrylonitrile-butadiene-styrene (ABS) copolymer, and polystyrene (PS). The tray 10 may include a loading area 100, a side wall 200, and a first air flow path 300.

In the loading area 100, a display panel may be loaded. The loading area 100 may provide a seating space in which the display panel may be seated, and may be formed to fit the size of the display panel so that the display panel may be fitted and seated. The loading area 100 may be implemented as a plate having a thickness, and a display panel may be seated and loaded on the upper surface of the loading area 100.

The loading area 100 may include a support member 110. The support member 110 may protrude upward from the upper surface of the loading area 100. The support member 110 may support a display panel seated on the loading area 100 so that the display panel is spaced by a distance upward from the upper surface of the loading area 100.

The side wall 200 may surround the loading area 100 on a face of the loading area 100. In other words, the side wall 200 may be extended to protrude upward from the upper surface of the loading area 100 in a thickness direction of the tray 10 and surround the border of the loading area 100 in a plan view. Since the side wall 200 may be extended to protrude upward from the upper surface of the loading area 100, the upper surface of the side wall 200 may be disposed at a higher position than the upper surface of the loading area 100. The side wall 200 may have a height sufficient to prevent the display panel from being separated from the loading area 100 when the display panel is seated in the loading area 100 and transported or stored. For example, the side wall 200 may have a height that is greater than at least the thickness of the display panel. The side wall 200 may be formed to have a width from the outside of the side wall 200 toward the loading area 100.

The side wall 200 may have a first side extended in a first direction DR1 and a second side extended in a second direction DR2 that intersects the first direction DR2. The length of the first side of the side wall 200 may be smaller than the length of the second side. In other words, the side wall 200 may have a rectangular shape in a plan view. For example, the side wall 200 may have a rectangular shape with shorter sides extended in the first direction DR1 and longer sides extended in the second direction DR2 in a plan view. The portions of the side wall 200 where the first sides extended in the first direction DR1 and the second side extended in the second direction DR2 meet each other may be formed at a right angle or rounded with a curvature. The first direction DR1 may be perpendicular to the second direction DR2 in the horizontal direction. However, the shape of the side wall 200 in a plan view is not limited to a rectangular shape, and the side wall 200 may be formed in a different polygonal shape, a circular shape, or an elliptical shape. The side wall 200 may be formed in various shapes depending on the shape of the display panel loaded on the loading area 100.

The side wall 200 may include stacking grooves 210. The stacking grooves 210 may be recessed from the upper surface of the side wall 200 in the thickness direction of the side wall 200. Multiple stacking grooves 210 may be provided and arranged along the side wall 200. The stacking grooves 210 may be formed in a same shape at a same location of each tray 10. To sequentially stack multiple trays 10, the stacking grooves 210 may be combined with one another to maintain the trays 10 to stacked on one another.

The first air flow path 300 may be located in the side wall 200 and may provide a passage for air outside the side wall 200 to flow into the loading area 100. The first air flow path 300 may be bent at least once. The first air flow path 300 may be located on the second side of the side wall 200. The first air flow path 300 may include a first inflow path 310, a first inclined path 320, a first discharge path 330, a first inflow expanded path 340, and a first discharge expanded path 350.

The first inflow path 310 may be extended from the outer surface of the side wall 200 toward the loading area 100. In other words, the first inflow path 310 may be extended from the outer surface of the side wall 200 in the first direction DR1.

The first inflow path 310 may be recessed from the surface of the side wall 200 in the thickness direction of the side wall 200. In other words, the first inflow path 310 may be recessed toward the inside of the side wall 200 from the upper surface of the side wall 200. The depth of the first inflow path 310 may be greater than half the total thickness of the side wall 200. A surface of the first inflow path 310 in the thickness direction of the side wall 200 may be formed as a curved surface. For example, the bottom surface of the first inflow path 310 may be formed in a round shape that is convex downward. The first inflow path 310 may provide a passage for air outside the side wall 200 to flow to the inside of the side wall 200.

The first inclined path 320 may be extended from the first inflow path 310 toward the loading area 100 in a direction different from the direction in which the first inflow path 310 is extended. In other words, the first inclined path 320 may be extended in a direction different from the first direction DR1 from an end of the first inflow path 310 that is closer to the loading area 100. The first inclined path 320 may have a first end connected to the first inflow path 310 and a second end connected to the first discharge path 330. The second end of the first inclined path 320 may be closer to the first side than the first end of the first inclined path 320 is. In other words, the first inclined path 320 may be extended from the first inflow path 310 such that it is inclined toward the first side. Since the first inclined path 320 is extended obliquely from the first inflow path 310, the first inclined path 320 may be bent from the first inflow path 310.

The first inclined path 320 may be recessed from the surface of the side wall 200 in the thickness direction of the side wall 200. In other words, the first inclined path 320 may be recessed toward the inside of the side wall 200 from the upper surface of the side wall 200. The depth of the first inclined path 320 may be greater than half the total thickness of the side wall 200. The depth of the first inclined path 320 may be equal to the depth of the first inflow path 310. A surface of the first inclined path 320 in the thickness direction of the side wall 200 may be formed as a curved surface. For example, the bottom surface of the first inclined path 320 may be formed in a round shape that is convex downward. The first inclined path 320 may provide a passage for the air outside the side wall 200 introduced through the first inflow path 310 to flow toward the loading area 100.

The first discharge path 330 may be extended from the first inclined path 320 to the loading area 100. In other words, the first discharge path 330 may be extended in the first direction DR1 from the second end of the first inclined path 320 that is closer to the loading area 100. Since the first discharge path 330 is extended in the first direction DR1 from the first inclined path 320, the first discharge path 330 may be bent from the first inclined path 320.

The first discharge path 330 may be recessed from the surface of the side wall 200 in the thickness direction of the side wall 200. In other words, the first discharge path 330 may be recessed toward the inside of the side wall 200 from the upper surface of the side wall 200. The depth of the first discharge path 330 may be greater than half the total thickness of the side wall 200. The depth of the first discharge path 330 may be equal to the depth of the first inflow path 310 and the depth of the first inclined path 320. A surface of the first discharge path 330 in the thickness direction of the side wall 200 may be formed as a curved surface. For example, the bottom surface of the first discharge path 330 may be formed in a round shape that is convex downward. The first discharge path 330 may provide a passage for the air outside the side wall 200 introduced through the first inclined path 320 to flow to the loading area 100.

The first inflow expanded path 340 may be located at an end of the first inflow path 310 closer to the outer surface of the side wall 200. The cross-sectional area of the first inflow expanded path 340 may be greater than the cross-sectional area of the first inflow path 310. For example, the first inflow expanded path 340 may be formed at the inlet of the first inflow path 310. The cross-sectional area of the first inflow expanded path 340 viewed in the first direction DR1 may be greater than the cross-sectional area of the first inflow path 310 viewed in the first direction DR1. The cross-sectional area of the first inflow expanded path 340 may gradually increase toward the outer surface of the side wall 200. For example, the cross-sectional area of the first inflow expanded path 340 viewed in the first direction DR1 may gradually increase from the end of the first inflow path 310 that is closer to the outer surface of the side wall 200 to the outer surface of the side wall 200.

The first discharge expanded path 350 may be located at an end of the first discharge path 330 that is closer to the loading area 100. The cross-sectional area of the first discharge expanded path 350 may be greater than the cross-sectional area of the first discharge path 330. For example, the first discharge expanded path 350 may be formed at the outlet of the first discharge path 330. The cross-sectional area of the first discharge expanded path 350 viewed in the first direction DR1 may be greater than the cross-sectional area of the first discharge path 330 viewed in the first direction DR1. The cross-sectional area of the first discharge expanded path 350 may gradually increase toward the loading area 100. For example, the cross-sectional area of the first discharge expanded path 350 viewed in the first direction DR1 may gradually increase toward the loading area 100 from the end of the first discharge path 330 that is closer to the loading area 100. The cross-sectional area of the end of the first discharge expanded path 350 that is closer to the loading area 100 viewed in the first direction DR1 may be smaller than the cross-sectional area of the end of the first inflow expanded path 340 that is closer to the outer surface of the side wall 200 viewed in the first direction DR1.

The air outside the side wall 200 may flow through the first inflow expanded path 340, the first inflow path 310, the first inclined path 320, the first discharge path 330, and the first discharge expanded path 350 in this order, such that air may flow from the outside of the side wall 200 to the loading area 100. As the first inflow path 310 and the first discharge path 330 are extended in the first direction DR1, and the first inclined path 320 connecting the first inflow path 310 with the first discharge path 330 is extended in a direction different from the first direction DR1, the first air flow path 300 may be bent at least once. If the first air flow path 300 is formed only in the first direction DR1, in case that the tray 10 is lifted up to transport the tray 10, there may be a risk that the display panel loaded on the tray 10 may be damaged because the location where the first air flow path 300 is formed may be bent. In contrast, according to the first embodiment of the disclosure, the first air flow path 300 of the tray 10 may be bent at least once, and thus it may be possible to prevent the location where the first air flow path 300 is formed from being bent in case that the tray 10 is lifted up.

Besides such configurations, a tray 10 according to a second embodiment of the disclosure may be provided. The second embodiment of the disclosure will be described with reference to the drawings. The second embodiment may be substantially identical to the first embodiment except that the second embodiment may further include a second air flow path 400; and, therefore, the redundant descriptions will be omitted.

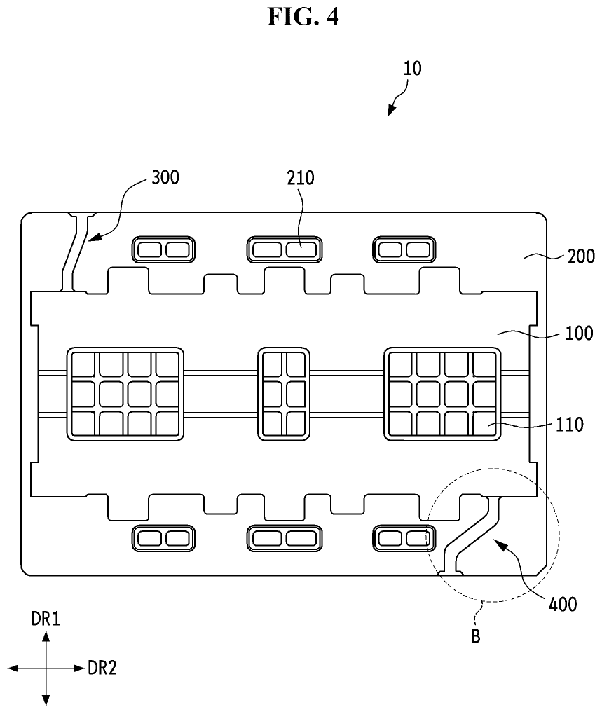

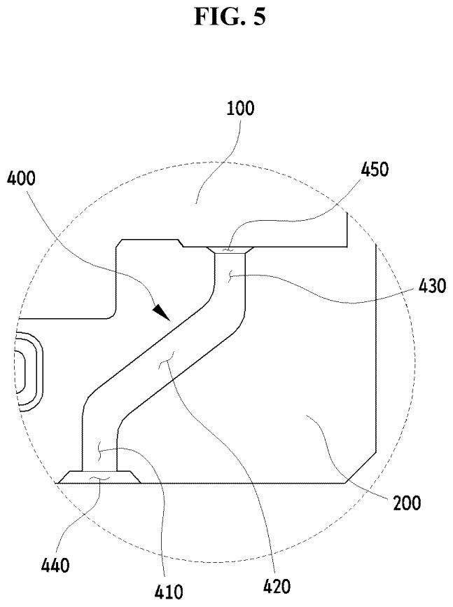

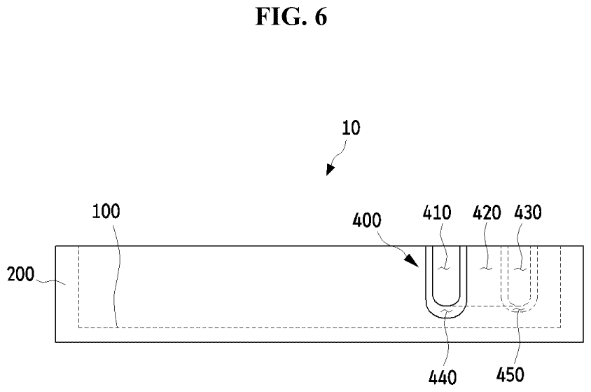

FIG. 4 is a plan view showing a tray according to a second embodiment of the disclosure. FIG. 5 is an enlarged view of portion B of FIG. 4. FIG. 6 is a side view of the tray viewed from a second air flow path of FIG. 4.

Referring to FIGS. 4 to 6, the tray 10 according to the second embodiment of the disclosure may include a loading area 100, a side wall 200, and multiple air flow paths 300 and 400. Since the loading area 100 and the side wall 200 according to the first embodiment and the second embodiment may have a same structure, the loading area 100 and the side wall 200 will not be described in detail.

The air flow paths may include a first air flow path 300 and a second air flow path. The first air flow path 300 may be located on the second side adjacent to a first vertex (upper left vertex in FIG. 4) of the side wall 200, and the second air flow path 400 may be located on the second side adjacent to a second vertex (lower right vertex in FIG. 4) that is diagonally opposite to the first vertex of the side wall 200. The first air flow path 300 and the second air flow path 400 may each be extended from an outer surface of the side wall 200 to the loading area 100. Since the first air flow path 300 according to the first embodiment and the second embodiment may have a same structure, the first air flow path 300 will not be described in detail.

The second air flow path 400 may provide a passage for air outside the side wall 200 to flow into the loading area 100. The second air flow path 400 may be bent at least once. The length of the second air flow path 400 may be different from the length of the first air flow path 300. The second air flow path 400 may include a second inflow path 410, a second inclined path 420, a second discharge path 430, a second inflow expanded path 440, and a second discharge expanded path 450.

The second inflow path 410 may be extended from an outer surface of the side wall 200 toward the loading area 100. In other words, the second inflow path 410 may be extended from the outer surface of the side wall 200 in the first direction DR1.

The second inflow path 410 may be recessed from the surface of the side wall 200 in the thickness direction of the side wall 200. In other words, the second inflow path 410 may be recessed toward the inside of the side wall 200 from the upper surface of the side wall 200. The depth of the second inflow path 410 may be greater than half the total thickness of the side wall 200. A surface of the second inflow path 410 in the thickness direction of the side wall 200 may be formed as a curved surface. For example, the bottom surface of the second inflow path 410 may be formed in a round shape that is convex downward. The second inflow path 410 may provide a passage for air outside the side wall 200 to flow to the inside of the side wall 200.

The second inclined path 420 may be extended from the second inflow path 410 toward the loading area 100 in a direction different from the direction in which the second inflow path 410 is extended. In other words, the second inclined path 420 may be extended in a direction different from the first direction DR1 from an end of the second inflow path 410 that is closer to the loading area 100. The second inclined path 420 may have a first end connected to the second inflow path 410 and a second end connected to the second discharge path 430. The second end of the second inclined path 420 may be closer to the first side adjacent to the second vertex than the first end of the second inclined path 420 is. In other words, the second inclined path 420 may be extended from the second inflow path 410 such that the second inclined path 420 is inclined toward the first side adjacent to the second vertex. Since the second inclined path 420 is extended obliquely from the second inflow path 410, the second inclined path 420 may be bent from the second inflow path 410. The length of the second inclined path 420 may be greater than the length of the first inclined path 320 of the first air flow path 300.

The second inclined path 420 may be recessed from the surface of the side wall 200 in the thickness direction of the side wall 200. In other words, the second inclined path 420 may be recessed toward the inside of the side wall 200 from the upper surface of the side wall 200. The depth of the second inclined path 420 may be greater than half the total thickness of the side wall 200. The depth of the second inclined path 420 may be equal to the depth of the second inflow path 410. A side of the second inclined path 420 in the thickness direction of the side wall 200 may be formed as a curved surface. For example, the bottom surface of the second inclined path 420 may be formed in a round shape that is convex downward. The second inclined path 420 may provide a passage for the air outside the side wall 200 introduced through the second inflow path 410 to flow toward the loading area 100.

The second discharge path 430 may be extended from the second inclined path 420 to the loading area 100. In other words, the second discharge path 430 may be extended in the first direction DR1 from the second end of the second inclined path 420 that is closer to the loading area 100 to be connected to the loading area 100. Since the second discharge path 430 is extended in the first direction DR1 from the second inclined path 420, the second discharge path 430 may be bent from the second inclined path 420.

The second discharge path 430 may be recessed from the surface of the side wall 200 in the thickness direction of the side wall 200. In other words, the second discharge path 430 may be recessed toward the inside of the side wall 200 from the upper surface of the side wall 200. The depth of the second discharge path 430 may be greater than half the total thickness of the side wall 200. The depth of the second discharge path 430 may be equal to the depth of the second inflow path 410 and the depth of the second inclined path 420. A surface of the second discharge path 430 in the thickness direction of the side wall 200 may be formed as a curved surface. For example, the bottom surface of the second discharge path 430 may be formed in a round shape that is convex downward. The second discharge path 430 may provide a passage for the air outside the side wall 200 introduced through the second inclined path 420 to flow to the loading area 100.

The second inflow expanded path 440 may be located at an end of the second inflow path 410 closer to the outer surface of the side wall 200. The cross-sectional area of the second inflow expanded path 440 may be greater than the cross-sectional area of the second inflow path 410. For example, the second inflow expanded path 440 may be formed at the inlet of the second inflow path 410. The cross-sectional area of the second inflow expanded path 440 viewed in the first direction DR1 may be greater than the cross-sectional area of the second inflow path 410 viewed in the first direction DR1. The cross-sectional area of the second inflow expanded path 440 may gradually increase toward the outer surface of the side wall 200. For example, the cross-sectional area of the second inflow expanded path 440 viewed in the first direction DR1 may gradually increase from the end of the second inflow path 410 that is closer to the outer surface of the side wall 200 to the outer surface of the side wall 200.

The second discharge expanded path 450 may be located at an end of the second discharge path 430 that is closer to the loading area 100. The cross-sectional area of the second discharge expanded path 450 may be greater than the cross-sectional area of the second discharge path 430. For example, the second discharge expanded path 450 may be formed at the outlet of the second discharge path 430. The cross-sectional area of the second discharge expanded path 450 viewed in the first direction DR1 may be greater than the cross-sectional area of the second discharge path 430 viewed in the first direction DR1. The cross-sectional area of the second discharge expanded path 450 may gradually increase toward the loading area 100. For example, the cross-sectional area of the second discharge expanded path 450 viewed in the first direction DR1 may gradually increase toward the loading area 100 from the end of the second discharge path 430 that is closer to the loading area 100. The cross-sectional area of the end of the second discharge expanded path 450 that is closer to the loading area 100 viewed in the first direction DR1 may be smaller than the cross-sectional area of the end of the second inflow expanded path 440 that is closer to the outer surface of the side wall 200 viewed in the first direction DR1.

The air outside the side wall 200 may flow through the second inflow expanded path 440, the second inflow path 410, the second inclined path 420, the second discharge path 430, and the second discharge expanded path 450 in this order, such that air may flow from the outside of the side wall 200 to the loading area 100. As the second inflow path 410 and the second discharge path 430 are extended in the first direction DR1, and the second inclined path 420 connecting the second inflow path 410 with the second discharge path 430 is extended in a direction different from the first direction DR1, the second air flow path 400 may be bent at least once. If the second air flow path 400 is formed only in the first direction DR1, in case that the tray 10 is lifted up to transport the tray 10, there may be a risk that the display panel loaded on the tray 10 may be damaged because the location where the second air flow path 400 is formed may be bent. In contrast, according to the second embodiment of the disclosure, the first air flow path 300 and the second air flow path 400 of the tray 10 may be bent at least once, and thus it may be possible to prevent the locations where the first air flow path 300 and the second air flow path are formed from being bent in case that the tray 10 is lifted up.

Besides such configurations, a tray 10 according to a third embodiment of the disclosure may be provided. The third embodiment of the disclosure will be described with reference to the drawings. The third embodiment may be substantially identical to the first and second embodiments except that the third embodiment may further include a third air flow path 500 and a fourth air flow path 600; and, therefore, the redundant descriptions will be omitted.

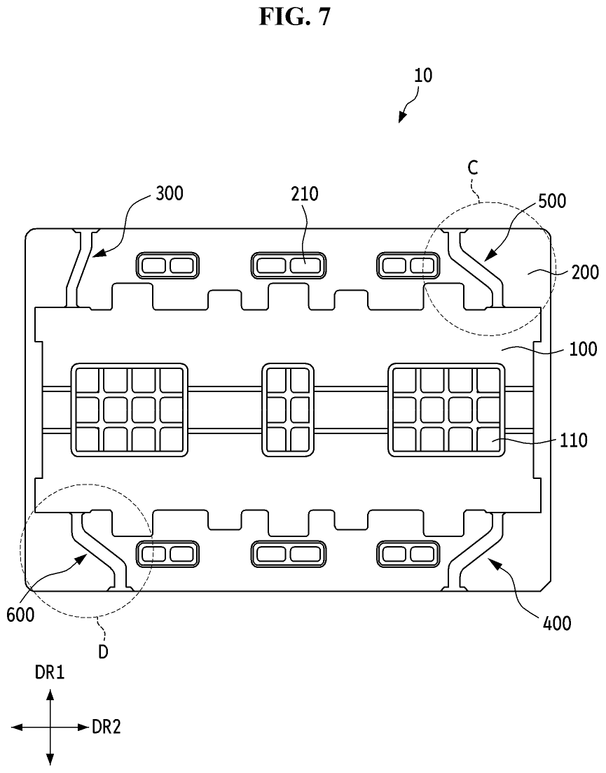

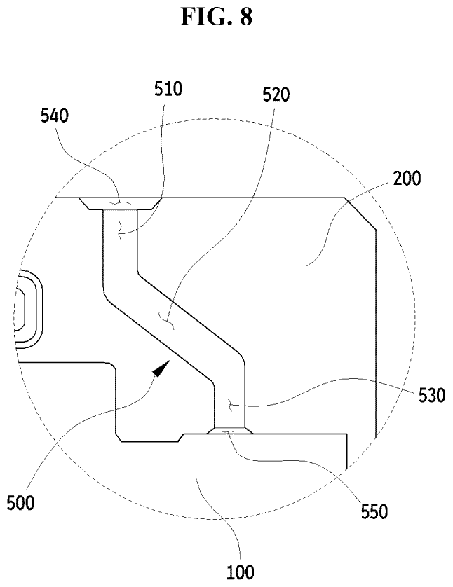

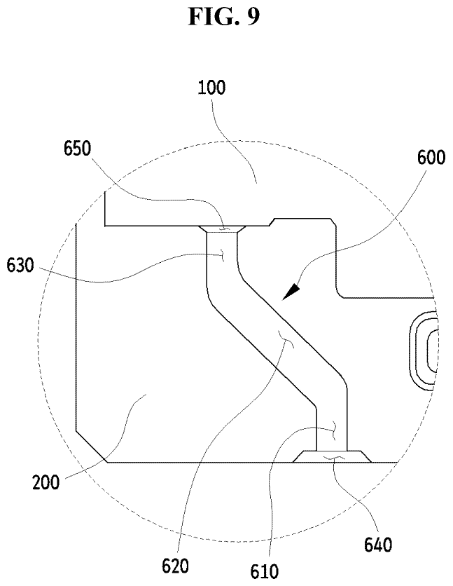

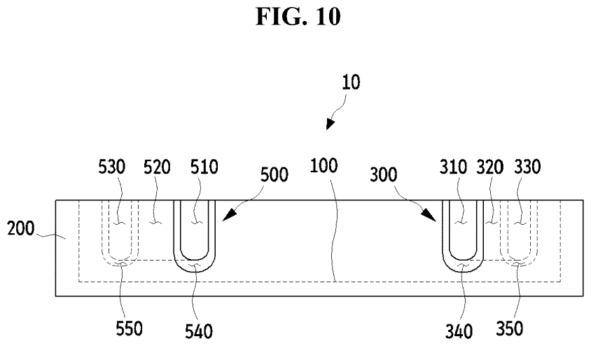

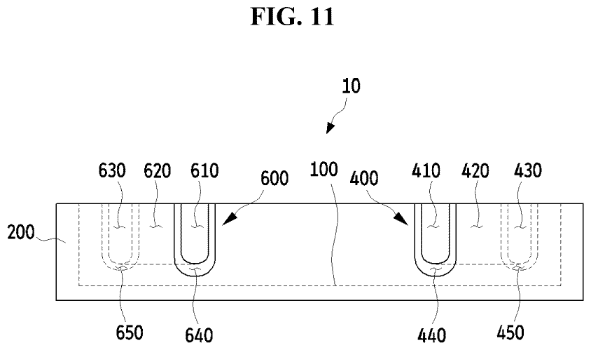

FIG. 7 is a plan view showing a tray according to a third embodiment of the disclosure. FIG. 8 is an enlarged view of portion C of FIG. 7. FIG. 9 is an enlarged view of portion D of FIG. 7. FIG. 10 is a side view of the tray viewed from the first air flow path and the third air flow path of FIG. 7. FIG. 11 is a side view of the tray viewed from the second air flow path and the fourth air flow path of FIG. 7.

Referring to FIGS. 7 to 11, a tray 10 according to the third embodiment of the disclosure may include a loading area 100, a side wall 200, and multiple air flow paths. Since the loading area 100 and the side wall 200 according to the first to third embodiments may have a same structure, the loading area 100 and the side wall 200 will not be described in detail.

The air flow paths may include a first air flow path 300, a second air flow path 400, a third air flow path 500, and a fourth air flow path 600. The first air flow path 300 may be located on the second side adjacent to a first vertex (upper left vertex in FIG. 7) of the side wall 200, and the second air flow path 400 may be located on the second side adjacent to a second vertex (lower right vertex in FIG. 7) that is diagonally opposite to the first vertex of the side wall 200. The third air flow path 500 may be located on the second side adjacent to a third vertex (upper right vertex in FIG. 7) of the side wall 200, and the fourth air flow path 600 may be located on the second side adjacent to a fourth vertex (lower left vertex in FIG. 7) of the side wall 200. In other words, the third air flow path 500 may be located on the second side of the side wall 200 where the first air flow path 300 is disposed, and may face the second air flow path 400 with the loading area 100 between the second air flow path 400 and the third air flow path 500. The fourth air flow path 600 may be located on the second side of the side wall 200 where the second air flow path 400 is disposed, and may face the first air flow path 300 with the loading area 100 between the first air flow path 300 and the fourth air flow path 600. The first air flow path 300, the second air flow path 400, the third air flow path 500 and the fourth air flow path 600 may each be extended from an outer surface of the side wall 200 to the loading area 100. Since the first air flow path 300 and the second air flow path 400 according to the first to third embodiments may have a same structure, the first air flow path 300 and the second air flow path 400 will not be described in detail.

The third air flow path 500 may provide a passage for air outside the side wall 200 to flow into the loading area 100. The third air flow path 500 may be bent at least once. The length of the third air flow path 500 may be different from the length of the first air flow path 300 or the length of the second air flow path 400. For example, the length of the third air flow path 500 may be greater than the length of the first air flow path 300, may be smaller than the length of the second air flow path 400, and may be equal to the length of the fourth air flow path 600. The third air flow path 500 may include a third inflow path 510, a third inclined path 520, a third discharge path 530, a third inflow expanded path 540, and a third discharge expanded path 550.

The third inflow path 510 may be extended from an outer surface of the side wall 200 toward the loading area 100. In other words, the third inflow path 510 may be extended from the outer surface of the side wall 200 in the first direction DR1.

The third inflow path 510 may be recessed from the surface of the side wall 200 in the thickness direction of the side wall 200. In other words, the third inflow path 510 may be recessed toward the inside of the side wall 200 from the upper surface of the side wall 200. The depth of the third inflow path 510 may be greater than half the total thickness of the side wall 200. A surface of the third inflow path 510 in the thickness direction of the side wall 200 may be formed as a curved surface. For example, the bottom surface of the third inflow path 510 may be formed in a round shape that is convex downward. The third inflow path 510 may provide a passage for air outside the side wall 200 to flow to the inside of the side wall 200.

The third inclined path 520 may be extended from the third inflow path 510 toward the loading area 100 in a direction different from the direction in which the third inflow path 510 is extended. In other words, the third inclined path 520 may be extended in a direction different from the first direction DR1 from an end of the third inflow path 510 that is closer to the loading area 100. The third inclined path 520 may have a first end connected to the third inflow path 510 and a second end connected to the third discharge path 530. The second end of the third inclined path 520 may be closer to the first side adjacent to the third vertex than the first end of the third inclined path 520 is. In other words, the third inclined path 520 may be extended from the third inflow path 510 such that the third inclined path 520 is inclined toward the first side adjacent to the third vertex. Since the third inclined path 520 is extended obliquely from the third inflow path 510, the third inclined path 520 may be bent from the third inflow path 510. The length of the third inclined path 520 may be greater than the length of the first inclined path 320 of the first air flow path 300, may be smaller than the length of the second inclined path 420 of the second air flow path 400, and may be equal to the length of a fourth inclined path 620 of the fourth air flow path 600, which will be described below.

The third inclined path 520 may be recessed from the surface of the side wall 200 in the thickness direction of the side wall 200. In other words, the third inclined path 520 may be recessed toward the inside of the side wall 200 from the upper surface of the side wall 200. The depth of the third inclined path 520 may be greater than half the total thickness of the side wall 200. The depth of the third inclined path 520 may be equal to the depth of the third inflow path 510. A surface of the third inclined path 520 in the thickness direction of the side wall 200 may be formed as a curved surface. For example, the bottom surface of the third inclined path 520 may be formed in a round shape that is convex downward. The third inclined path 520 may provide a passage for the air outside the side wall 200 introduced through the third inflow path 510 to flow toward the loading area 100.

The third discharge path 530 may be extended from the third inclined path 520 to the loading area 100. In other words, the third discharge path 530 may be extended in the first direction DR1 from the second end of the third inclined path 520 that is closer to the loading area 100 to be connected to the loading area 100. Since the third discharge path 530 is extended in the first direction DR1 from the third inclined path 520, the third discharge path 530 may be bent from the third inclined path 520.

The third discharge path 530 may be recessed from the surface of the side wall 200 in the thickness direction of the side wall 200. In other words, the third discharge path 530 may be recessed toward the inside of the side wall 200 from the upper surface of the side wall 200. The depth of the third discharge path 530 may be greater than half the total thickness of the side wall 200. The depth of the third discharge path 530 may be equal to the depth of the third inflow path 510 and the depth of the third inclined path 520. A surface of the third discharge path 530 in the thickness direction of the side wall 200 may be formed as a curved surface. For example, the bottom surface of the third discharge path 530 may be formed in a round shape that is convex downward. The third discharge path 530 may provide a passage for the air outside the side wall 200 introduced through the third inclined path 520 to flow to the loading area 100.

The third inflow expanded path 540 may be located at an end of the third inflow path 510 closer to the outer surface of the side wall 200. The cross-sectional area of the third inflow expanded path 540 may be greater than the cross-sectional area of the third inflow path 510. For example, the third inflow expanded path 540 may be formed at the inlet of the third inflow path 510. The cross-sectional area of the third inflow expanded path 540 viewed in the first direction DR1 may be greater than the cross-sectional area of the third inflow path 510 viewed in the first direction DR1. The cross-sectional area of the third inflow expanded path 540 may gradually increase toward the outer surface of the side wall 200. For example, the cross-sectional area of the third inflow expanded path 540 viewed in the first direction DR1 may gradually increase from the end of the third inflow path 510 that is closer to the outer surface of the side wall 200 to the outer surface of the side wall 200.

The third discharge expanded path 550 may be located at an end of the third discharge path 530 that is closer to the loading area 100. The cross-sectional area of the third discharge expanded path 550 may be greater than the cross-sectional area of the third discharge path 530. For example, the third discharge expanded path 550 may be formed at the outlet of the third discharge path 530. The cross-sectional area of the third discharge expanded path 550 viewed in the first direction DR1 may be greater than the cross-sectional area of the third discharge path 530 viewed in the first direction DR1. The cross-sectional area of the third discharge expanded path 550 may gradually increase toward the loading area 100. For example, the cross-sectional area of the third discharge expanded path 550 viewed in the first direction DR1 may gradually increase toward the loading area 100 from the end of the third discharge path 530 that is closer to the loading area 100. The cross-sectional area of the end of the third discharge expanded path 550 that is closer to the loading area 100 viewed in the first direction DR1 may be smaller than the cross-sectional area of the end of the third inflow expanded path 540 that is closer to the outer surface of the side wall 200 viewed in the first direction DR1.

The fourth air flow path 600 may provide a passage for air outside the side wall 200 to flow into the loading area 100. The fourth air flow path 600 may be bent at least once. The length of the fourth air flow path 600 may be different from the length of the first air flow path 300 or the length of the second air flow path 400. For example, the length of the fourth air flow path 600 may be greater than the length of the first air flow path 300, may be smaller than the length of the second air flow path 400, and may be equal to the length of the third air flow path 500. The fourth air flow path 600 may include a fourth inflow path 610, a fourth inclined path 620, a fourth discharge path 630, a fourth inflow expanded path 640, and a fourth discharge expanded path 650.

The fourth inflow path 610 may be extended from an outer surface of the side wall 200 toward the loading area 100. In other words, the fourth inflow path 610 may be extended from the outer surface of the side wall 200 in the first direction DR1.

The fourth inflow path 610 may be recessed from the surface of the side wall 200 in the thickness direction of the side wall 200. In other words, the fourth inflow path 610 may be recessed toward the inside of the side wall 200 from the upper surface of the side wall 200. The depth of the fourth inflow path 610 may be greater than half the total thickness of the side wall 200. A surface of the fourth inflow path 610 in the thickness direction of the side wall 200 may be formed as a curved surface. For example, the bottom surface of the fourth inflow path 610 may be formed in a round shape that is convex downward. The fourth inflow path 610 may provide a passage for air outside the side wall 200 to flow to the inside of the side wall 200.

The fourth inclined path 620 may be extended from the fourth inflow path 610 toward the loading area 100 in a direction different from the direction in which the fourth inflow path 610 is extended. In other words, the fourth inclined path 620 may be extended in a direction different from the first direction DR1 from an end of the fourth inflow path 610 that is closer to the loading area 100. The fourth inclined path 620 may have a first end connected to the fourth inflow path 610 and a second end connected to the fourth discharge path 630. The second end of the fourth inclined path 620 may be closer to the first side adjacent to the fourth vertex than the first end of the fourth inclined path 620 is. In other words, the fourth inclined path 620 may be extended from the fourth inflow path 610 such that the fourth inclined path 620 is inclined toward the first side adjacent to the fourth vertex. Since the fourth inclined path 620 is extended obliquely from the fourth inflow path 610, the fourth inclined path 620 may be bent from the fourth inflow path 610. The length of the fourth inclined path 620 may be greater than the length of the first inclined path 320 of the first air flow path 300, may be smaller than the length of the second inclined path 420 of the second air flow path 400, and may be equal to the length of the third inclined path 520 of the third air flow path 500.

The fourth inclined path 620 may be recessed from the surface of the side wall 200 in the thickness direction of the side wall 200. In other words, the fourth inclined path 620 may be recessed toward the inside of the side wall 200 from the upper surface of the side wall 200. The depth of the fourth inclined path 620 may be greater than half the total thickness of the side wall 200. The depth of the fourth inclined path 620 may be equal to the depth of the fourth inflow path 610. A surface of the fourth inclined path 620 in the thickness direction of the side wall 200 may be formed as a curved surface. For example, the bottom surface of the fourth inclined path 620 may be formed in a round shape that is convex downward. The fourth inclined path 620 may provide a passage for the air outside the side wall 200 introduced through the fourth inflow path 610 to flow toward the loading area 100.

The fourth discharge path 630 may be extended from the fourth inclined path 620 to the loading area 100. In other words, the fourth discharge path 630 may be extended in the first direction DR1 from the second end of the fourth inclined path 620 that is closer to the loading area 100 to be connected to the loading area 100. Since the fourth discharge path 630 is extended in the first direction DR1 from the fourth inclined path 620, the fourth discharge path 630 may be bent from the fourth inclined path 620.

The fourth discharge path 630 may be recessed from the surface of the side wall 200 in the thickness direction of the side wall 200. In other words, the fourth discharge path 630 may be recessed toward the inside of the side wall 200 from the upper surface of the side wall 200. The depth of the fourth discharge path 630 may be greater than half the total thickness of the side wall 200. The depth of the fourth discharge path 630 may be equal to the depth of the fourth inflow path 610 and the depth of the fourth inclined path 620. A surface of the fourth discharge path 630 in the thickness direction of the side wall 200 may be formed as a curved surface. For example, the bottom surface of the fourth discharge path 630 may be formed in a round shape that is convex downward. The fourth discharge path 630 may provide a passage for the air outside the side wall 200 introduced through the fourth inclined path 620 to flow to the loading area 100.

The fourth inflow expanded path 640 may be located at an end of the fourth inflow path 610 closer to the outer surface of the side wall 200. The cross-sectional area of the fourth inflow expanded path 640 may be greater than the cross-sectional area of the fourth inflow path 610. For example, the fourth inflow expanded path 640 may be formed at the inlet of the fourth inflow path 610. The cross-sectional area of the fourth inflow expanded path 640 viewed in the first direction DR1 may be greater than the cross-sectional area of the fourth inflow path 610 viewed in the first direction DR1. The cross-sectional area of the fourth inflow expanded path 640 may gradually increase toward the outer surface of the side wall 200. For example, the cross-sectional area of the fourth inflow expanded path 640 viewed in the first direction DR1 may gradually increase from the end of the fourth inflow path 610 that is closer to the outer surface of the side wall 200 to the outer surface of the side wall 200.

The fourth discharge expanded path 650 may be located at an end of the fourth discharge path 630 that is closer to the loading area 100. The cross-sectional area of the fourth discharge expanded path 650 may be greater than the cross-sectional area of the fourth discharge path 630. For example, the fourth discharge expanded path 650 may be formed at the outlet of the fourth discharge path 630. The cross-sectional area of the fourth discharge expanded path 650 viewed in the first direction DR1 may be greater than the cross-sectional area of the fourth discharge path 630 viewed in the first direction DR1. The cross-sectional area of the fourth discharge expanded path 650 may gradually increase toward the loading area 100. For example, the cross-sectional area of the fourth discharge expanded path 650 viewed in the first direction DR1 may gradually increase toward the loading area 100 from the end of the fourth discharge path 630 that is closer to the loading area 100. The cross-sectional area of the end of the fourth discharge expanded path 650 that is closer to the loading area 100 viewed in the first direction DR1 may be smaller than the cross-sectional area of the end of the fourth inflow expanded path 640 that is closer to the outer surface of the side wall 200 viewed in the first direction DR1.

The air outside the side wall 200 may flow through the third inflow expanded path 540, the third inflow path 510, the third inclined path 520, the third discharge path 530, and the third discharge expanded path 550 in this order, such that air may flow from the outside of the side wall 200 to the loading area 100. The air outside the side wall 200 may flow through the fourth inflow expanded path 640, the fourth inflow path 610, the fourth inclined path 620, the fourth discharge path 630, and the fourth discharge expanded path 650 in this order, such that air may flow from the outside of the side wall 200 to the loading area 100.

As the third inflow path 510 and the third discharge path 530 are extended in the first direction DR1, and the third inclined path 520 connecting the third inflow path 510 with the third discharge path 530 is extended in a direction different from the first direction DR1, the third air flow path 500 may be bent at least once. As the fourth inflow path 610 and the fourth discharge path 630 are extended in the first direction DR1, and the fourth inclined path 620 connecting the fourth inflow path 610 with the fourth discharge path 630 is extended in a direction different from the first direction DR1, the fourth air flow path 600 may be bent at least once. If the third air flow path 500 and the fourth air flow path 600 are formed only in the first direction DR1, in case that the tray 10 is lifted up to transport the tray 10, there may be a risk that the display panel loaded on the tray 10 may be damaged because the locations where the third air flow path 500 and the fourth air flow path 600 are formed may be bent. In contrast, according to the third embodiment of the disclosure, the first air flow path 300, the second air flow path 400, the third air flow path 500 and the fourth air flow path 600 of the tray 10 may be bent at least once, and thus it may be possible to prevent the locations where the first air flow path 300, the second air flow path 400, the third air flow path 500 and the fourth air flow path 600 are formed from being bent in case that the tray 10 is lifted up.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A tray comprising:
a loading area where a display panel is loaded;
a side wall disposed on a surface of the loading area to surround the loading area; and
an air flow path located in the side wall to provide a passage for air outside the side wall to flow into the loading area,
wherein the air flow path is bent at least once.

2. The tray of claim 1, wherein
the side wall has a first side extended in a first direction and a second side extended in a second direction intersecting the first direction,
a length of the first side is smaller than a length of the second side, and
the air flow path is located on the second side of the side wall.

3. The tray of claim 2, wherein the air flow path comprises:
an inflow path extended from an outer surface of the side wall toward the loading area;
an inclined path extended from the inflow path toward the loading area, the inflow path and the inclined path extending different directions; and
a discharge path extended from the inclined path to the loading area.

4. The tray of claim 3, wherein a first end of the inclined path that is connected to the discharge path is closer to the first side than a second end of the inclined path that is connected to the inflow path.

5. The tray of claim 3, wherein the discharge path and the inflow path are extended in a same direction.

6. The tray of claim 3, wherein the air flow path further comprises:
an inflow expanded path disposed at an end of the inflow path that is located closer to the outer surface of the side wall,
wherein a cross-sectional area of the inflow expanded path is greater than a cross-sectional area of the inflow path viewed in the first direction.

7. The tray of claim 6, wherein the cross-sectional area of the inflow expanded path gradually increases toward the outer surface of the side wall.

8. The tray of claim 3, wherein the air flow path further comprises:
a discharge expanded path disposed at an end of the discharge path that is located closer to the loading area,
wherein a cross-sectional area of the discharge expanded path is greater than a cross-sectional area of the discharge path viewed in the first direction.

9. The tray of claim 8, wherein the cross-sectional area of the discharge expanded path gradually increases toward the loading area.

10. The tray of claim 1, wherein
the air flow path is recessed from a surface of the side wall in a thickness direction of the side wall, and
a depth of the air flow path is greater than half a thickness of the side wall.

11. The tray of claim 10, wherein a bottom surface of the air flow path in the thickness direction of the side wall is formed as a curved surface.

12. A tray comprising:
a loading area where a display panel is loaded;
a side wall disposed on a surface of the loading area to surround the loading area; and
a plurality of air flow paths located in the side wall to provide passages for air outside the side wall to flow into the loading area, wherein
the plurality of air flow paths are extended from an outer surface of the side wall to the loading area, and
one of the plurality of air flow paths and another one of the plurality of air flow paths have different lengths.

13. The tray of claim 12, wherein
the side wall has first sides extended in a first direction and second sides extended in a second direction intersecting the first direction,
a length of each of the first sides is smaller than a length of each of the second sides, and
the plurality of air flow paths are located on the second sides of the side wall.

14. The tray of claim 13, wherein
the side wall is formed in a rectangular shape in a plan view,
the plurality of air flow paths comprises a first air flow path and a second air flow path,
the first air flow path is located on one of the second sides adjacent to a vertex, and
the second air flow path is located on another one of the second sides adjacent to another vertex located diagonally opposite to the vertex.

15. The tray of claim 14, wherein
the first air flow path comprises:
a first inflow path extended from the outer surface of the side wall toward the loading area;
a first inclined path extended from the first inflow path toward the loading area, the first inflow path and the first inclined path extending different directions; and
a first discharge path extended from the first inclined path to the loading area, the second air flow path comprises:
a second inflow path extended from the outer surface of the side wall toward the loading area;
a second inclined path extended from the second inflow path toward the loading area, the second inflow path and the second inclined path extending different directions; and
a second discharge path extended from the second inclined path to the loading area, and
a length of the first inclined path is smaller than a length of the second inclined path.

16. The tray of claim 15, wherein
a first end of the first inclined path that is connected to the first discharge path is closer to one of the first sides adjacent to the vertex than a second end of the first inclined path that is connected to the first inflow path, and
a first end of the second inclined path that is connected to the second discharge path is closer to another one of the first sides adjacent to the another vertex than a second end of the second inclined path that is connected to the second inflow path.

17. The tray of claim 14, wherein
the plurality of air flow paths further comprises a third air flow path and a fourth air flow path,
the third air flow path is located on the one of the second sides, and
the fourth air flow path is located on the another one of the second sides.

18. The tray of claim 17, wherein
the third air flow path faces the second air flow path with the loading area between the second air flow path and the third air flow path, and
the fourth air flow path faces the first air flow path with the loading area between the first air flow path and the fourth air flow path.

19. The tray of claim 17, wherein
the third air flow path comprises:
a third inflow path extended from the outer surface of the side wall toward the loading area;
a third inclined path extended from the third inflow path toward the loading area, the third inflow path and the third inclined path extending different directions; and
a third discharge path extended from the third inclined path to the loading area, the fourth air flow path comprises:
a fourth inflow path extended from the outer surface of the side wall toward the loading area;
a fourth inclined path extended from the fourth inflow path toward the loading area, the fourth inflow path and the fourth inclined path extending different directions; and
a fourth discharge path extended from the fourth inclined path to the loading area, and
a length of the third inclined path is equal to a length of the fourth inclined path.

20. The tray of claim 19, wherein
a first end of the third inclined path that is connected to the third discharge path is closer to the another one of the first sides adjacent to the another vertex than a second end of the third inclined path that is connected to the third inflow path, and
a first end of the fourth inclined path that is connected to the fourth discharge path is closer to the one of the first sides adjacent to the vertex than a second end of the fourth inclined path that is connected to the fourth inflow path.
